(19) United States
(12) Patent Application Publication
(10) Pub. No.: US 2003/0206832 A1
(43) Pub. Date: Nov. 6, 2003

(54) Stacked microfluidic device

(76) Inventors: Pierre Thiebaud, Cressier (CH); Pascal Mayer, Eloise (FR); Eric Chevalier, Veyrier du Lac (FR)

Correspondence Address: PENNIE AND EDMONDS, 1155 AVENUE OF THE AMERICAS, NEW YORK, NY, 100362711

(21) Appl. No.: 10/138,889

(22) Filed: May 2, 2002

(51) Int. Cl. B01L 3/02; G01N 1/10

(52) U.S. Cl. 422/100; 422/99; 436/180; 435/287.1; 435/287.3; 435/288.5

(57) ABSTRACT

The microfluidic dispensing device includes a patterned seal having a specified arrangement of holes and groves, and an connection plate having passages corresponding to the holes in the patterned seal. The patterned seal and the connection plate are configured to stack onto a planar substrate, such as a glass slide, and are sealed together and against the substrate by a negative pressure, or vacuum, applied through the connection plate. When the patterned seal is secured against the substrate, the grooves in the patterned seal form a network of channels for delivering fluids to specified regions on the substrate. The connection plate preferably includes one or more connectors for attaching fluid and/or vacuum lines, and optionally includes one or more sensors to monitor operation of the device. The system of the present invention also includes a device for automatically assembling and handling the microfluidic dispensing device.

### BACKGROUND OF THE INVENTION

1. Technical Field of the Invention

The present invention relates to fluid dispensers. More specifically, the invention relates to a modular microfluidic device and system for dispensing fluids to a substrate.

2. Description of Related Art

Microfabricated devices are used in a wide variety of industries, ranging from integrated circuits and microprocessors used in the electronics industry to, in more recent applications, microfluidic devices and systems used in the pharmaceutical, chemical and biotechnology industries.

Most available microfluidic devices are permanently bonded or sealed at the time of manufacturing, such that the interior spaces defining the microfluidic channels are not openly accessible after bonding. This inaccessibility leads to difficulties, for example, with chemically treating the internal surfaces, waste removal, and cleaning. In applications where the microfluidic channels are used as reaction chambers, problems may occur with respect to cross contamination due to fluid handling.

Some microfluidic systems are manufactured such that they are reconfigurable (See D. Duffy, O. Schueller, J. Cooper McDonald & G. Whitesides, Anal. Chem. Vol.70 n.23, 1998). For example, some microfluidic devices are capable of being opened and resealed during the lifetime of the device. Such devices generally consist of layers of plastic or others materials that are bonded with removable adhesive under room temperature and regular pressure. However, the bonded area does not always form an effective seal, for example due to stressed material, microleaks, or other problems that may develop at other than optimal bonding temperatures. In addition, chemical resistance or contamination from adhesives may pose a problem in such devices.

Another limitation of available microfluidic devices is that they are generally not compatible with automated liquid handlers utilizing microtiter plates having 96 wells or multiples thereof, e.g., 384 wells or more. Such microtiter plates are the pharmaceutical industry standard for carrying out bioanalytical assays despite the recent advances in miniaturization and microfluidics. Because an enormous number of synthetic libraries have been, and continue to be, generated using this particular multiwell format, the microtiter plate will remain entrenched within the industry.

A number of different robotic liquid handling systems have been developed to automate various tasks in performing high-throughput assays and other procedures in the biotechnology and pharmaceutical industries. Such robotic systems perform rapidly and accurately to perform such tedious liquid handling tasks as assay set-up, sample dispensing, microtiter plate washing, etc. However, integration of microfluidic technology with existing robotic-based methods currently used in automated workstations is constrained, for example, by differences in volume or size of samples used. Moreover, currently available automated liquid handling systems do not provide for the assembly and management of a number of modular, reusable microfluidic devices.

Thus, a need exists for an improved, reusable microfluidic delivery device and an automated system for assembling and handling such a device. New automated methods for multiplexing common lab tasks such as sample handling and dispensing at the micro-scale are needed. This is especially the case for slides and other planar substrates upon which a number of chemical analyses such as solid-phase macromolecule attachment approaches are processed.

### SUMMARY OF THE INVENTION

The present invention overcomes the disadvantages and limitations of the related art by providing a reusable microfluidic device having interdependent modular components that seal together under vacuum pressure. In particular, the microfluidic dispensing device of the present invention includes a patterned seal having a specified arrangement of holes and grooves, and a connection plate having passages corresponding to the holes in the patterned seal. The connection plate and the patterned seal are configured to stack onto a planar substrate, such as a glass slide, and are sealed together and against the substrate by a negative pressure, or vacuum, applied through the connection plate. When the patterned seal is secured against the substrate, the grooves in the patterned seal form a network of channels for delivering fluids to specified regions on the substrate. The connection plate preferably includes one or more connectors for attaching fluid and/or vacuum lines, and optionally includes one or more sensors to monitor operation of the microfluidic device. The present invention also provides a system for automatically assembling and handling the microfluidic dispensing device.

Accordingly, the present invention provides a reusable microfluidic device that can be easily disassembled for changing substrates and/or for cleaning. Such a microfluidic device is preferably configured to be used in conjunction with existing microtiter plates, thereby leveraging existing synthetic libraries. Moreover, assembly of the microfluidic device occurs without the use of adhesives, thereby reducing contamination concerns.

### DESCRIPTION OF THE DRAWINGS

These and other features, aspects, and advantages of the present invention will become more readily apparent from the following detailed description, which should be read in conjunction with the accompanying drawings in which:

FIG. 1 is a schematic exploded view of a microfluidic device according to the present invention;

FIG. 2 is a schematic cross-sectional view of a microfluidic device of the present invention having at least two components bonded by vacuum pressure;

FIG. 3 is a schematic cross-sectional view of another embodiment of the microfluidic device of the present invention; and

FIGS. 4A-C are schematic views of the surface of any one of the elements of the microfluidic device, e.g., patterned seal, or connection plate/cover.

Like reference numerals refer to corresponding parts throughout the several views of the drawings.

### DETAILED DESCRIPTION OF THE PREFERRED EMBODIMENTS

The structure and function of the preferred embodiments of the systems, devices and methods of the present invention can best be understood by reference to the drawings. Where the same reference designations appear in multiple locations in the drawings, the numerals refer to the same or corresponding structure in those locations. While the invention will be described in conjunction with the preferred embodiments, it will be understood that they are not intended to limit the invention to those embodiments. On the contrary, the invention is intended to cover alternatives, modifications, and equivalents, which may be included within the invention as defined by the appended claims.

Definitions

It is to be understood that the terminology used herein is for purposes of describing particular embodiments only, and is not intended to be limiting. As used in the specification and the appended claims, the singular forms “a”, “an” and “the” include plural referents unless the context clearly dictates otherwise. Thus, for example, reference to “a detection means” includes one or more such detection means, reference to “a fluid reservoir compartment” includes one or more such compartments, etc.

Unless stated otherwise, the following terms and phrases as used herein are intended to have the following meanings:

The term “microscale” or “microfabricated” generally refers to structural elements or features of a device which have at least one fabricated dimension in the range of from about 0.1 μm to about 5000 μm. Thus, a device referred to as being microfabricated or microscale will include at least one structural element or feature having such a dimension. When used to describe a fluidic element, such as a passage, chamber, or conduit, the terms “microscale”, “microfabricated” or “microfluidic” generally refer to one or more fluid passages, chamber or conduits which have at least one internal cross-sectional dimension, e.g., depth width, length, diameter, etc., that is less than 5000 μm, and typically between 0.1 μm and 200 μm.

The term “connection plate” refers to a device that interfaces with a patterned seal. The connection plate also preferably interfaces with measurement devices; fluid supplies and devices; vacuum supplies and devices; the environment; or the like. The term “plate” is not intended to necessarily mean planar in shape. Rather, the connection plate may be any suitable shape and can be made of any suitable material/s. The connection plate may include one or more inlet and/or outlet ports, for example for passing fluids or for applying a vacuum. The connection plate may also include one or more channels a network of channels and/or grooves that communicate with the inlet and/or outlet port/s.

The term “patterned seal” refers to a device that interfaces with at least one element. The patterned seal, may be any of any suitable shape and be made of any suitable material/s, such as polymers or a combination of polymers with ceramics, glass, semi-conductors, etc. In use, the patterned seal preferably provides a hermetic or fluid-tight seal with the connection plate. The patterned seal may include one or more inlet and/or outlet ports, for example for channeling fluids or for applying a vacuum. The patterned seal may also include one or more channels and/or grooves that communicate with the inlet and/or outlet port/s.

The term “substrate” refers to a surface of any suitable shape and made of any suitable material/s, e.g., for supporting biological samples. Examples of suitable materials include ceramics, glass, semi-conductors, polymers, any combinations of the aforementioned, or the like. The substrate may include one or more inlet and/or outlet ports, for example for passing fluids or for applying a vacuum. The substrate may also include one or more channels and/or grooves that communicate with the inlet and/or outlet port/s.

The term “connection cover” refers to an integrated connection plate and patterned seal, that interfaces with the substrate. The connection cover is of any suitable shape and is made of any suitable material/s. The connection cover forms a hermetic and/or fluid-tight seal with a substrate, e.g., under application of negative pressure. The connection cover may include one or more inlet and/or outlet ports, for example for passing fluids or for applying a vacuum. The connection cover may also include one or more channels and/or grooves that communicate with the inlet and/or outlet port/s.

The term “element” refers to a connection plate, a patterned seal, a substrate, or a connection plate/cover, as described herein.

The term “micropositioning system” refers to a system, which allows the positioning of elements relative to one another.

The term “sensor” refers to a measurement device which allows the measurement of any detectable variable, such as physical, chemical and biological values.

The term “actuators” refers to a device which modifies any physical, chemical and biological values.

The term “vacuum” refers to any negative differential pressure compared to the environment.

The term “port” refers to a passage between the environment and an element or between two elements, such as a connection plate, a patterned seal, or a substrate. The ports provide access for fluids or vacuum between elements. For example, a connection plate may include a port that interfaces with a fluid or vacuum source on one side of the plate and communicates with a patterned seal and/or substrate on the other side of the plate.

The term “detection means” refers to any device, structure or configuration that queries a sample within a sample processing compartment using analytical detection techniques well known in the art. Thus, a detection means includes one or more apertures, elongated apertures, or grooves which communicate with the sample processing compartment and allow a detection device or device to be interfaced with the sample processing compartment to detect an analyte passing through or positioned in the compartment. The detection means may also comprise an optical detection device, such as a microscope, CCD camera, or other optical detector to detect optical properties, such as reflected light, scattered light, or fluorescent light.

The Preferred Embodiments

This invention encompasses stacked and vacuum-bonded microfluidic elements and a device for dispensing fluids from one or more fluid reservoirs to substrate, such as one or more microscope slides or planar surfaces. As will be shown below, this allows for automatic fluid handling, which is particularly useful for high throughput screening applications, including pharmaceutical drug discovery, genomic, proteomic, and chemical sciences applications.

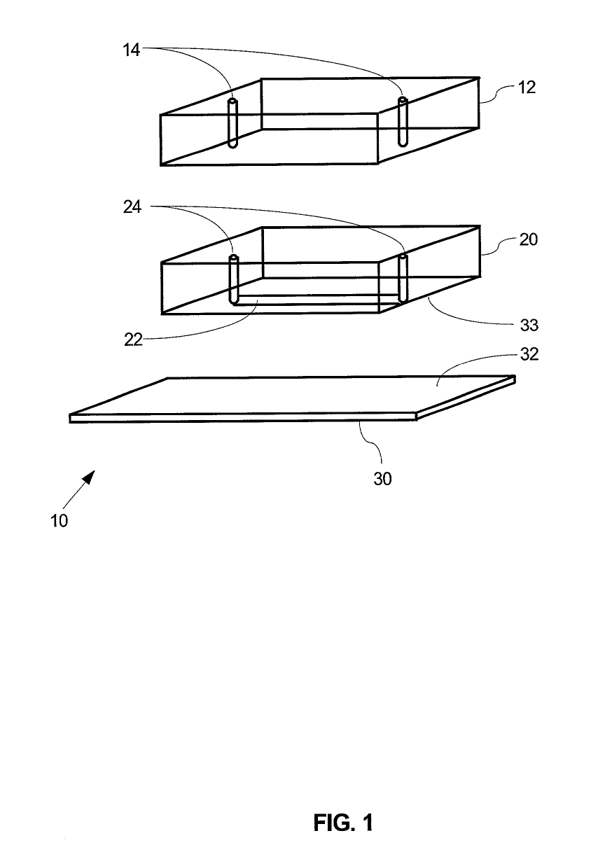

The structure of the microfluidic devices described herein preferably includes an aggregation of two or more separate elements which when appropriately joined together, form the microfluidic device of the invention. Referring to microfluidic device 10 of FIG. 1 as an example, the microfluidic devices described herein generally comprise a patterned seal 20 inserted or sandwiched between a connection plate 12 and a substrate 30.

The substrate 30 is preferably any substantially rigid planar structure having at least one substantially planar upper surface 32 configured to mate with a corresponding substantially planar lower surface 33 of the patterned seal 20. Substrate 30 is made from any suitable material/s, such as polymers, plastics, resins, carbon, metals, inorganic glasses, silicon, etc. In an embodiment used in conjunction with an optical detection means, the substrate is preferably made of a substantially transparent material. Moreover, the patterned seal 20 is preferably slightly compressible to ensure an airtight seal with adjoining elements. Also in a preferred embodiment, the upper surface 32 is non reactive to liquids deposited thereon. In another embodiment, the upper surface 32 contains reactive functionalities for binding to a component of a liquid deposited thereon. In yet another embodiment, the surface contains one or more reagents for conducting a chemical analysis or synthesis. In one embodiment, the substrate includes an array of chemicals or biomolecules, such as nucleic acids, peptides, lipids, glucides, or the like, attached to a surface adjacent to the patterned seal.

The patterned seal 20 may have any suitable shape such as a disk, square, or the like. The patterned seal 20 is preferably constructed of one or more polymer materials that are compatible with injected fluids and are chemically neutral. Such polymer materials are selected for their ease of manufacture, low cost and disposability. Also, the patterned seal 20 preferably has desirable optical properties such as a lack of auto-fluorescence, which is of particular importance when chemical analysis requires fluorescence characterizations. In addition, patterned seal 20 preferably conforms with physical requirements that limit its behavior under high temperature, pressure, or the like. The patterned seal materials are also generally selected for their compatibility with the full range of conditions to which the microfluidic devices may be exposed, including extremes of pH, temperature, and salt concentrations.

Moreover, because the microfluidic devices are microfabricated, patterned seal materials are selected upon their compatibility with known microfabrication techniques, e.g., photolithography, wet and dry chemical etching, laser ablation, abrasion techniques, injection molding, hot embossing, and other techniques. Such materials are readily manufactured using available microfabrication techniques, as described above, or from microfabricated masters, using well known molding techniques, such as injection molding, embossing, stamping, casting (see U.S. Pat. No. 5,512,131), or the like. Again, these materials may include treated surfaces, e.g., derivatized or coated surfaces, to enhance their utility in the microfluidic system.

In another preferred embodiment, the patterned seal is manufactured with at least two polymers. Indeed, it is useful to have one part made with a rigid plastic for handling, positioning, good mechanical characteristics, while another part is made from a second polymer that has physical properties convenient for sealing with the substrate. In a particularly preferred embodiment, one of the two polymers is an elastomeric material, such as but not limited to polydimethyl siloxane (PDMS).

The patterned seal is manufactured with one or more holes and grooves required for fluid transfer and vacuum interfaces. Referring again to FIG. 1, patterned seal 20 preferably includes two passages 24 that pass all the way through patterned seal 20 from an upper surface adjacent the connection plate 12 to a lower surface adjacent the substrate 30. Preferably, one the of passages 24 is a fluid inlet passage and another is a fluid outlet passage. One or more grooves 22 formed in the lower surface of patterned seal 22 connect passages 24. As discussed below, when the patterned seal 20 mates with the upper surface 32 of substrate 30, the grooves 22 form a channel or network of channels for delivering fluid to and/or from discrete regions on surface 32 of substrate 30.

Grooves 22 such as those on device 10 may be fabricated into the surface of the patterned seal 20 or a portion of the patterned seal in contact with the substrate and/or the connection plate 12. These grooves are fabricated as microscale grooves or indentations using the above described microfabrication techniques.

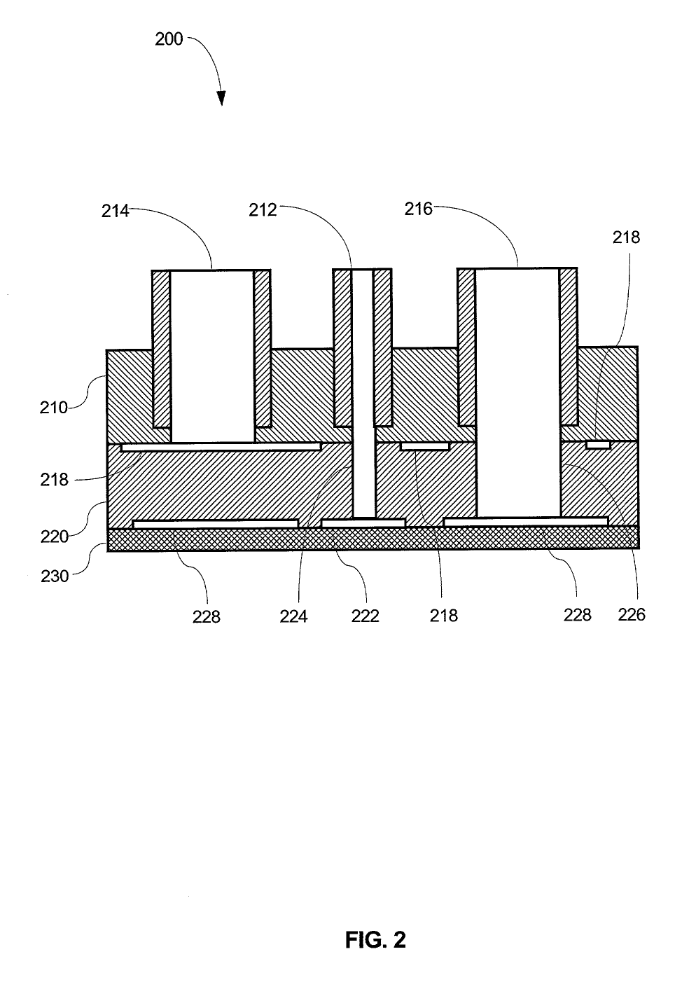

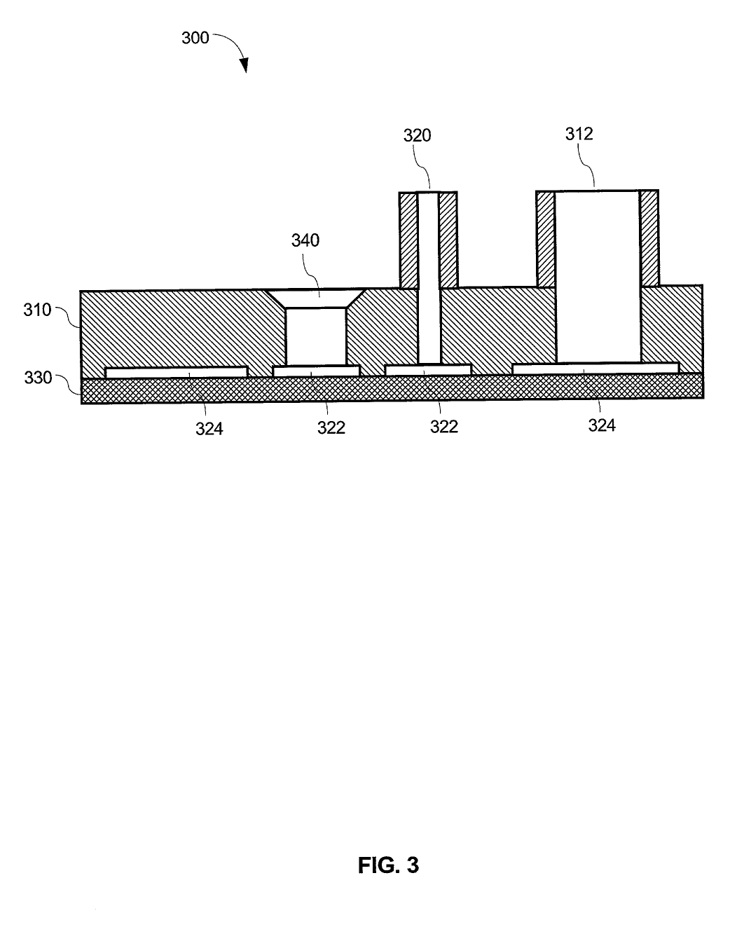

Moreover, the elements preferably include a series of grooves or cavities extending from one or more vacuum port/s to ensure an adequate binding force is maintained between the various elements, as described below in relation to FIGS. 2 and 3.

In use, the lower surface 33 of the patterned seal 20 is mated, or placed into contact, with the upper surface 32 of the substrate 30 and a vacuum applied to seal the upper surface 32 of the substrate 30 to the connection plate 12. This encloses and seals the grooves 22 and/or indentations in the surface of the patterned seal to form the channels and/or cavities of the device at the interface of these elements. The passages 24 of the patterned seal are orientated such that they are in communication with at least one of the channels and/or grooves formed at the patterned seal/substrate interface. In use, these passages 24 may form reservoirs for facilitating fluid or material introduction into the channels or cavities of the interior portion of the device.

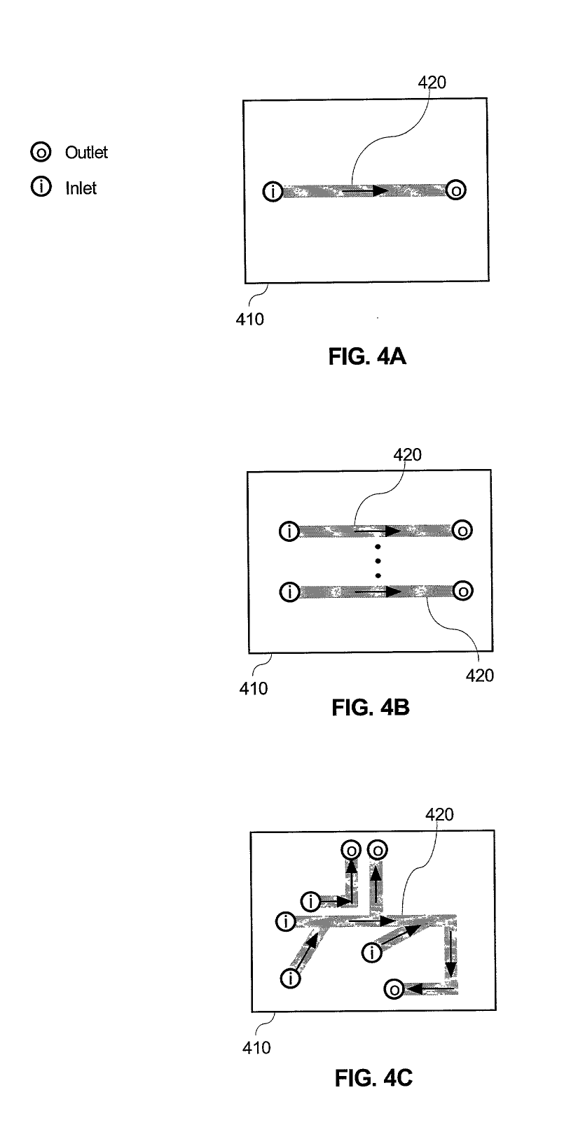

Once the patterned seal 20 is applied to the substrate 30 and/or the connection plate 12, each groove 22 defines a microchannel. It is possible to design a network of holes and grooves to define an intricate fluid channel network as mentioned above. Such a network may have any convenient design, depending upon the particular application. It should, however, be appreciated that the precise arrangement of microchannels is not crucial to the operation of the invention. One exemplary arrangement of microchannels developed and tested by the applicants utilizes a plurality of microchannels arranged parallel to each other on a substantially rectangular substrate (See FIGS. 4A-4C).

The above described elements may also comprise a micropositioning system having one or more alignment structures or surface features for maintaining the elements in a set, predefined position relative to one another. Such alignment structures or surface features may take a variety of forms, including, e.g., alignment pins, alignment ridges, walls, or wells disposed upon the elements to ensure alignment of the elements in their appropriate positions, e.g., aligning the vacuum port/s and/or fluid port/s. Alternatively, the elements may be aligned using other suitable micro-positioning techniques, such as electromagnetic forces.

The connection plate 12 includes holes or ports 14 that are manufactured and positioned to correspond to passages 24 in the patterned seal 20. The plate 12 is preferably equipped with connectors (not shown) for fluid and/or vacuum lines. The connection plate 12 is preferably made of materials that are compatible with the fluids used and having the required optical and/or physical properties (behavior with temperature, etc.). Connection plate 12 is of any convenient shape such as disk, square, and the like.

In a preferred embodiment, the connection plate 12 has a useful life that exceeds that of the patterned seal 20 and the substrate 30. In other words, numerous substrates may be used with the same connection plate. In use, the patterned seal 20 is generally replaced each time a substrate is changed, to avoid cross contamination. In an alternative embodiment, the three elements may be reused after washing or cleaning depending on the fluids employed.

Moreover, sensors may be added to the elements, especially the connecting plate, in order to monitor the control of fluid transfer, or biological/chemical reactions in the device. Suitable sensors include: electrochemical sensors; temperature sensors; optical sensors; mechanical sensors; or the like. An example of such a sensor is a micro-velocimeter sensor that monitors the flow of the fluid in the device.

Thus, as described above, a fluidic phase sample processing device may be formed, having a flow path extending from a first end of a microchannel to a second end thereof, by communicating fluids from an associated source (not shown) through the inlet port, passing the fluids through a sample processing compartment formed by the alignment of the microchannels, and allowing the fluids to exit the sample processing compartment via an outlet port. In this manner, a wide variety of fluidic phase handling may be carried out in the subject microfluidic device using techniques well known in the art. Furthermore, various means for applying a motive force along the length of the sample processing compartment, such as pressure differential or electric potential, may be provided. For example, a pressure differential may be provided between the inlet and the outlet 14.

One or more inlet ports 14 may be provided, such that a variety of external fluids and/or sample introduction devices may be readily interfaced with the microfluidic device. Such means include, but are not limited to, external pressure injection, hydrodynamic injection, electrokinetic injection mechanisms, or the like. Similarly, one or more outlet ports may be provided such that a variety of external fluids and/or sample introductions devices may be readily interfaced with the microfluidic device. Such devices include, but are not limited to peristaltic pumps, syringe pumps, etc.

Buffers or reagents held in a fluid reservoir compartment may be delivered to a sample processing compartment, a sample flow component, or a sample treatment component reservoir compartment via connecting microchannels. Fluid flow from the reservoir compartment to the sample processing compartment may occur via passive diffusion. Optionally, the fluid may be displaced from the reservoir compartment by an actuator means. A variety of micropumps and microvalves that will find utility as an actuator means according to the invention disclosed herein are well known in the art and have been described, for example in Manz et al. (1993) Adv. Chromatogr. 33:1-66 and references cited therein.

FIG. 2 shows a schematic cross section of an assembled microfluidic device 200 according to the present invention. As with device 10, device 200 generally includes a connection plate 210, a patterned seal 220 and a substrate 230. Connection plate 210 includes vacuum ports 214, 216, each of which passes through the connection plate 210 to the patterned seal 220. In a preferred embodiment, at least one vacuum port 216 continues through patterned seal 220 via a passage 226 and terminates in one or more grooves or cavities 228 in communication with substrate 230 such that negative pressure, or vacuum, applied through port 216 and passage 226 binds the substrate 230 against patterned seal 220. Similarly, vacuum port 214 preferably passes through the connection plate 210 and terminates in one or more grooves or cavities 218 in the patterned seal 220, such that a vacuum applied through port 214 seals connection plate 210 against patterned seal 220. Alternatively, grooves or cavities 218 may be formed in the connection plate instead of, or in addition to, those in patterned seal 220. In yet another embodiment, grooves or cavities 218 and 228 may not be necessary to provide the required vacuum seal to bind the various elements together.

In use, vacuum ports 214 and 216 are connected via a vacuum line to a vacuum source (not shown), e.g., a vacuum pump. Vacuum pumping can be applied either continuously or intermittently. If applied intermittently, the vacuum can be maintained by hermetically sealing the vacuum port/s and/or vacuum line/s after initial application of negative pressure. This allows sufficient negative pressure to remain in grooves and/or cavities 218 and 228 and seal the elements, 210, 220 and 230 together.

In one embodiment, a portable vacuum pump is coupled to the connection plate to enable the microfluidic device 200 to be easily moved. This is especially useful for moving the device between different characterization sites (microscopy, spectrometry, etc.). Such a vacuum pump may be integral with, or separate from, the microfluidic device. An example of a suitable integral pump is a integrated or micro pump.

Furthermore, connection plate 210 includes ports for fluid inlet and outlet 212. These ports for fluid inlet and outlet 212 connect to one or more grooves or channels 222. To ensure flow inside these channels 222, pumps such as a syringe pumps or peristaltic pump, may be used. Such pumps are preferably connected to the ports 212 of the connection plate 210 via tubes (not shown).

FIG. 3 shows a cross-sectional view of another embodiment of a microfluidic device 300 according to the present invention. Rather than having a separate connection plate and patterned seal as discussed above, device 300 has an integrated connection plate and patterned seal assembly 310 (also termed herein “connection cover”), that seals with substrate 330 under negative pressure applied through at least one vacuum port 312. The connection cover 310 is of any suitable shape and is made of any suitable material/s. The connection cover 310 preferably comprises one or more fluid passages 320 that communicate with one or more grooves 322 that communicate with a surface of substrate 330. The at least one vacuum port 312 passes through the cover 310 and terminates in one or more grooves and/or cavities 324 that communicate with substrate 330, such as around a perimeter of the substrate 330. In use, when vacuum is applied through port 312, substrate 330 is sealed against cover 310.

Alternatively, the fluid inlet 212 or 320 can be larger to serve as a reservoir 340 for pipetting. These reservoirs 340 are preferably used with an automated pipetting apparatus. In addition, the spacing between fluid inlets is preferably compatible with existing 96 well plates.

In order to optimize sealing between the cover 310 and the substrate 330, connection cover 310 can be manufactured with two or more materials. For example, a first material may be used at the interface with the substrate 330 to form a seal and to optimize the sealing of the cover. Polymer is a suitable first material. The rest of cover 310, may be made of a second material that is substantially rigid (e.g., plastic, metal, or the like) to implement ports, connectors, and to allow for a convenient design.

FIGS. 4A-C shows schematic views of the surface of any one of the elements of a microfluidic device of the invention, e.g., patterned seal or connection plate/cover. When the patterned seal mates with surface of the substrate and/or the connection cover 410, grooves 420 form a network of channels for delivering fluid to and/or from discrete regions of the surface of the substrate and/or the connection cover 410. There may be one microscale groove (FIG. 4A), a plurality of microscale grooves (FIG. 4B), or any other suitable network of microscale grooves (FIG. 4C).

Another aspect of the invention (not shown) is an device that simultaneously and automatically manages the assembly of a number of stacked microfluidic devices, in parallel, and performs a range of liquid handling tasks. In one embodiment, the invention relates to an device with a large platform where a number of connecting plates are positioned. A robotic system loads a patterned seal and a substrate on each connection plate. The platform can be thermally controlled to ensure specific temperatures at the substrate level. This platform may be placed on a XYZ stage to characterize samples on the substrates.

In another embodiment, the invention relates to an device which consists of two platforms. The bottom one receives substrates, and the top one is equipped with connecting plates. Automatically or manually the patterned seals are placed on each connecting plate. An automation system in the vertical axis moves the top platform down to the bottom one. The sealing between interfaces is ensured by vacuum.

In yet another embodiment, multiple substrates may be stacked one on top of another. In this embodiment, a seal is positioned between each substrate and vacuum and/or fluid inlet and/or outlet ports may pass through the substrates.

All references cited herein are incorporated herein by reference in their entirety and for all purposes to the same extent as if each individual publication or patent or patent application was specifically and individually indicated to be incorporated by reference in its entirety for all purposes.

The foregoing descriptions of specific embodiments of the present invention are presented for purposes of illustration and description. They are not intended to be exhaustive or to limit the invention to the precise forms disclosed, obviously many modifications and variations are possible in view of the above teachings. For example, a thermal control device or sensors may be integrated within one or more of the elements. The embodiments were chosen and described in order to best explain the principles of the invention and its practical applications, to thereby enable others skilled in the art to best utilize the invention and various embodiments with modifications as are suited to the particular use contemplated. Furthermore, the order of steps in the method are not necessarily intended to occur in the sequence laid out. It is intended that the scope of the invention be defined by the following claims and their equivalents.

What is claimed is:

1. A microfluidic device, comprising:
a connection plate having at least one port passing through said connection plate; and
a patterned seal having a passage corresponding to said port, said patterned seal configured to sealingly attach between said connection plate and a substrate, wherein at least two of the group consisting of said connection plate, said patterned seal, and the substrate are held together by vacuum.

2. The device of claim 1, wherein said patterned seal further comprises at least one groove on a surface distal said connection plate, such that said at least one groove forms a at least one fluid channel communicating with said substrate when said patterned seal attaches to said substrate.

3. The device of claim 2, wherein the substrate is planar.

4. The device of claim 3, wherein the substrate is a glass slide.

5. The device of claim 1, further comprising a substrate coupled to the patterned seal.

6. The device of claim 5, wherein the substrate includes an array of one or more chemicals or biomolecules attached to a surface adjacent to said patterned seal.

7. The device of claim 5, wherein said patterned seal removably seals against said substrate by the vacuum.

8. The device of claim 1, wherein said patterned seal removably seals against said connection plate by the vacuum.

9. The device of claim 5, wherein an outer surface of said connection plate includes a connector communicating with the port, said connector for coupling a fluid source or a vacuum source with said port.

10. The device of claim 1, wherein an outer surface of said connection plate includes a connector communicating with the port, said connector for coupling a fluid source or a vacuum source with said port.

11. The device of claim 10, wherein the connector is configured to attach to a vacuum source for providing a vacuum to the device.

12. The device of claim 11, further comprising the vacuum source attached to the connector.

13. The device of claim 12, wherein said connection plate further comprises a second port, and said patterned seal further comprises a second passage corresponding to the second port, wherein said second port and said second passage provide a fluid to said substrate.

14. The device of claim 1, wherein said patterned seal comprises a second port for providing a fluid or a vacuum.

15. The device of claim 14, further comprising a vacuum source coupled to said second port for providing vacuum.

16. The device of claim 14, further comprising a fluid source coupled to said second port for providing fluid.

17. The device of claim 1, wherein said substrate comprises a second port for providing a fluid or vacuum.

18. The device of claim 17, further comprising a vacuum source coupled to said second port for providing vacuum.

19. The device of claim 17, further comprising a fluid source coupled to said second port for providing fluid.

20. The device of claim 1, further comprising a thermal control device integrated within at least said connection plate, said patterned seal, or said substrate.

21. The device of claim 1, further comprising a sensor integrated within at least said connection plate, said patterned seal, or said substrate.

22. The device of claim 21, further comprising an actuator integrated within at least said connection plate, said patterned seal, or said substrate.

23. The device of claim 1, further comprising an actuator integrated within at least said connection plate, said patterned seal, or said substrate.

24. The device of claim 1, wherein said connection plate includes a micropositioning system.

25. The device of claim 24, wherein said micropositioning system is a surface feature for aiding alignment.

26. The device of claim 1, wherein said patterned seal includes a surface feature for aiding alignment with said connection plate.

27. The device of claim 1, wherein said patterned seal includes a micropositioning system.

28. The device of claim 27, wherein said micropositioning system is a surface feature for aiding alignment.

29. The device of claim 1, wherein said substrate includes a micropositioning system.

30. The device of claim 29, wherein said micropositioning system is a surface feature for aiding alignment.

31. The device of claim 1, further comprising a plurality of substrates and a plurality of patterned seals attached to form a desired combination of layers.

32. The device of claim 31, wherein at least one of said plurality of patterned seals is bonded with at least one substrate by vacuum.

33. The device of claim 31, further comprising a plurality of connection plates, wherein each of said plurality of connection plates attaches with at least one substrate or patterned seal.

34. The device of claim 33, wherein at least one of said plurality of connection plates bonds with at least one patterned seal by vacuum.

35. The device of claim 1, further comprising a plurality of connection plates, wherein at least one of said plurality of connection plates attaches with at least one patterned seal.

36. The device of claim 35, wherein at least one of said plurality of connection plates bonds with said at least one patterned seal by vacuum.

37. The device of claim 1, wherein the patterned seal is integral with the connection plate.

38. The device of claim 37, wherein said patterned seal further comprises a network of grooves that communicate with said substrate when said patterned seal attaches to said substrate.

39. The device of claim 38, wherein the substrate is planar.

40. The device of claim 39, wherein the substrate is a glass slide.

41. The device of claim 37, further comprising the substrate.

42. The device of claim 41, wherein said patterned seal removably seals against said substrate by the vacuum.

43. The device of claim 42, further comprising a vacuum source communicating with said integrated connector plate and patterned seal.

44. The device of claim 37, wherein an outer surface of said connection plate includes a connector communicating with the port, said connector for coupling a fluid source or a vacuum source with said port.

45. The device of claim 44, further comprising a vacuum source attached to the connector.

46. The device of claim 44, further comprising a fluid source attached to said connector.

47. The device of claim 37, further comprising a thermal control device integrated within at least said connection plate, said patterned seal, or said substrate.

48. The device of claim 37, further comprising a sensor integrated within at least said connection plate, said patterned seal, or said substrate.

49. The device of claim 48, further comprising an actuator integrated within at least said connection plate, said patterned seal, or said substrate.

50. The device of claim 37, further comprising an actuator integrated within at least said connection plate, said patterned seal, or said substrate.

51. The device of claim 37, further comprising a plurality of substrates and a plurality of patterned seals attached to form a desired combination of layers.

52. The device of claim 51, wherein at least one of said plurality of patterned seals is bonded with at least one substrate by vacuum.

53. The device of claim 52, further comprising a plurality of connection plates, wherein each of said plurality of connection plates attaches with at least one substrate or patterned seal.

54. The device of claim 53, wherein at least one of said plurality of connection plates bonds with said at least one substrate or patterned seal by vacuum.

55. The device of claim 37, further comprising a plurality of connection plates, wherein each of said plurality of connection plates attaches with at least one substrate or patterned seal.

56. The device of claim 55, wherein at least one of said plurality of connection plates bonds with said at least one substrate or patterned seal by vacuum.

57. The device of claim 37, wherein said substrate comprises an array of one or more chemicals or biomolecules attached to a surface adjacent to said patterned seal.

58. A microfluidic device, comprising:
a connection plate having at least one fluid port and a vacuum port passing through the connection plate from a first side to a second side of said connection plate;
a patterned seal adjacent to the second side of said connection plate, said patterned seal having a vacuum passage communicating with the vacuum port, a fluid passage communicating with the fluid port, and a network of grooves communicating with the fluid passage; and
a substrate sealed against said patterned seal such that said network of grooves form a network of fluid channels communicating with discrete positions on a surface of said substrate, wherein vacuum applied through said vacuum port removably bonds said substrate with said patterned seal.

59. A microfluidic device, comprising:
a connection plate having at least one fluid port and a vacuum port passing through the connection plate from a first side to a second side of said connection plate; and
a patterned seal adjacent to the second side of said connection plate, said patterned seal having a vacuum passage communicating with the vacuum port, a fluid passage communicating with the fluid port, and a network of grooves communicating with the fluid passage,
wherein said connection cover seals against said patterned seal such that the network of grooves forms a network of fluid channels communicating with discrete positions on a surface of a substrate, wherein vacuum applied through the vacuum port removably bonds said connection cover with said patterned seal.

60. A microfluidic device, comprising:
a connection plate having at least one fluid port and two vacuum ports passing through the connection plate from a first side to a second side of said connection plate;
a patterned seal adjacent to the second side of said connection plate, said patterned seal having vacuum passages communicating with the vacuum ports, a fluid passage communicating with the fluid port, and a network of grooves communicating with the fluid passage; and
a substrate sealed against said patterned seal such that the network of grooves form a network of fluid channels communicating with discrete positions on a surface of said substrate,
wherein vacuum applied through the vacuum ports removably bonds said patterned seal with said substrate and with said connection plate.

61. The device of claim 60, wherein said substrate comprises an array of one or more chemicals or biomolecules attached to a surface adjacent to said patterned seal.
